(19) United States
(12) Patent Application Publication
(10) Pub. No.: US 2026/0166491 A1
(43) Pub. Date: Jun. 18, 2026

(54) SYSTEMS AND METHODS FOR ELECTROCHEMICAL EXTRACTION OF A TARGET ION

(71) Applicant: Vanderbilt University, Nashville, TN (US)

(72) Inventors: Shihong LIN, Nashville, TN (US); Xudong ZHANG, Nashville, TN (US)

(21) Appl. No.: 19/421,468

(22) Filed: Dec. 16, 2025

Related U.S. Application Data
(60) Provisional application No. 63/734,809, filed on Dec. 17, 2024.
(60) Provisional application No. 63/800,633, filed on May 6, 2025.

(51) Int. Cl. B01D 61/48; B01D 61/46; C22B 3/24; C22B 3/42; C22B 4/02; C22B 4/08; H01M 10/54

(52) U.S. Cl. CPC B01D 61/485; B01D 61/463; B01D 61/466; C22B 3/24; C22B 3/42; C22B 4/02; C22B 4/08; B01D 2313/345; H01M 10/54

(57) ABSTRACT

The disclosed subject matter relates to system and methods for electrochemical extractions of target ions, such as lithium.

### CROSS-REFERENCE TO RELATED APPLICATIONS

This application claims the benefit of priority to U.S. Provisional Application No. 63/734,809, filed Dec. 17, 2024, and U.S. Provisional Application No. 63/800,633, filed May 6, 2025, each of which is hereby incorporated herein by reference in its entirety.

### BACKGROUND

Improved devices and methods for desalination, water softening, and selective extraction of minerals and other valuable ions are needed. The devices, systems, and methods disclosed herein address these and other needs.

### SUMMARY

In accordance with the purposes of the disclosed compositions, methods, and systems as embodied and broadly described herein, the disclosed subject matter relates to system and methods for electrochemical extractions of target ions, such as lithium.

For example, described herein are systems for electrochemical extraction of a target ion, the systems comprising: at least one set of alternating sorbent chambers and eluate chambers defined by a plurality of alternating ion exchange membranes, the plurality of alternating ion exchange membranes being: at least one set of alternating anion exchange membranes and cation exchange membranes, or at least one set of alternating bipolar membranes and cation exchange membranes. Each of the ion exchange membranes forms a boundary between the alternating sorbent chambers and eluate chambers. Each of the ion exchange membranes are in electrochemical and liquid communication with a neighboring pair of sorbent chambers and eluate chambers. Each of the sorbent chambers further contains a target ion-selective /rbent/ The systems further comprise a pair of terminal electrodes; and a power source; wherein the pair of terminal electrodes and the power source are configured to apply an electrical field across the alternating sorbent chambers and eluate chambers when a closed circuit is formed between the pair of terminal electrodes and power source. During operation, the system is configured to sequentially operate an adsorption stage and a desorption stage. During the adsorption stage: the pair of terminal electrodes are not connected to the power source, such that no electrical field is applied across the alternating sorbent chambers and eluate chambers, each sorbent chamber is configured to receive a feed solution comprising the target ion, thereby contacting the target ion-selective sorbent with the feed solution, such that the target ion-selective sorbent selectively adsorbs the target ion from the feed solution. Subsequently, during the desorption stage: each sorbent chamber is configured to receive a diluate solution; each eluate chamber is configured to receive a receiving solution; wherein the diluate solution and receiving solution each have an initially low concentration of the target ion; a closed circuit is formed between the pair of terminal electrodes and the power source, such that the pair of terminal electrodes and the power source are configured to apply an electrical field across the alternating sorbent chambers and eluate chambers; such that the target ion adsorbed by the target ion-selective sorbent elutes from the target ion-selective sorbent to the receiving solution, thereby forming a target ion recovery solution.

In some examples, each of the cation exchange membranes is a monovalent-selective cation exchange membrane.

In some examples, the plurality of alternating ion exchange membranes is at least one set of alternating anion exchange membranes and cation exchange membranes, such as a plurality of alternating anion exchange membranes and cation exchange membranes.

In some examples, the target ion comprises an anion, such as chlorides, phosphates, nitrates, sulfates, borates, and/or carbonates.

In some examples, the target ion comprises a critical mineral.

In some examples, the target ion comprises a metal, such as an alkaline metal, a transition metal, a rare earth metal, or a combination thereof.

In some examples, the target ion comprises sodium, lithium, calcium, nickel, copper, cobalt, or a combination thereof.

In some examples, the target ion comprises sodium, lithium, calcium, or a combination thereof.

In some examples, the target ion comprises lithium.

In some examples, the target ion is lithium, and the target ion-selective sorbent is a lithium-selective sorbent.

Also disclosed herein are systems for electrochemical lithium extraction, the systems comprising: at least one set of alternating sorbent chambers and eluate chambers defined by at least one set of alternating anion exchange membranes and cation exchange membranes. Each of the anion exchange membranes and cation exchange membranes forms a boundary between the alternating sorbent chambers and eluate chambers. Each of the anion exchange membranes and cation exchange membranes are in electrochemical and liquid communication with a neighboring pair of sorbent chambers and eluate chambers. Each of the sorbent chambers further contains a lithium-selective sorbent. The systems further comprise a pair of terminal electrodes; and a power source; wherein the pair of terminal electrodes and the power source are configured to apply an electrical field across the alternating sorbent chambers and eluate chambers when a closed circuit is formed between the pair of terminal electrodes and power source. During operation, the system is configured to sequentially operate an adsorption stage and a desorption stage. During the adsorption stage: the pair of terminal electrodes are not connected to the power source, such that no electrical field is applied across the alternating sorbent chambers and eluate chambers, each sorbent chamber is configured to receive a feed solution comprising lithium, thereby contacting the lithium-selective sorbent with the feed solution, such that the lithium-selective sorbent selectively adsorbs lithium from the feed solution. Subsequently, during the desorption stage: each sorbent chamber is configured to receive a diluate solution; each eluate chamber is configured to receive a receiving solution; wherein the diluate solution and receiving solution each have an initially low concentration of lithium; a closed circuit is formed between the pair of terminal electrodes and the power source, such that the pair of terminal electrodes and the power source are configured to apply an electrical field across the alternating sorbent chambers and eluate chambers; such that the lithium adsorbed by the lithium-selective sorbent elutes from the lithium-selective sorbent to the receiving solution, thereby forming a lithium recovery solution.

In some examples, the lithium-selective sorbent comprises a layered double hydroxide (LDH), lithium titanate (Li₄Ti₅O₁₂, LTO) or its delithiated form (e.g., hydrogen titanate, HTO), lithium manganese oxide (LiMn₂O₄, LMO) or its delithiated form (e.g., hydrogen manganese oxide, HMO), lithium titanium manganate oxides (LTMO) or its delithiated form, other functionalized materials, derivatives thereof (e.g., their modified/doped forms), or a combination thereof.

In some examples, each of the sorbent chambers further comprises an anion exchange resin configured to adsorb competing anions from the feed solution during the adsorption stage, such as chlorides, phosphates, nitrates, sulfates, borates, and/or carbonates.

In some examples, each of the feed solutions, diluate solutions, and/or receiving solutions further comprises a solvent, such as water (e.g., each of the feed solutions, diluate solutions, and/or receiving solutions is an aqueous solution).

In some examples, the feed solution is derived from a natural source or a waste stream.

In some examples, the feed solution comprises brackish water, salt lake brine, geothermal brine, seawater, oil and/or gas produced water, mining wastewater, leaching solution in battery recovery, brine from reverse osmosis or other desalination processes, or a combination thereof.

In some examples, the feed solution comprises a brine.

In some examples, the feed solution has a total dissolved solids content of from greater than 0 to 400,000 ppm, such as from greater than 0 to 250,000 ppm. In some examples, the feed solution has a total dissolved solids content of from 500 to 100,000 ppm.

In some examples, the diluate solution comprises freshwater.

In some examples, the receiving solution comprises an electrolyte.

In some examples, the concentration of the target ion (e.g., lithium) in the target ion recovery solution (e.g., lithium recovery solution) is sufficiently high such that subsequent concentration steps are unnecessary. In some examples, the concentration of the target ion (e.g., lithium) in the target ion recovery solution (e.g., lithium recovery solution) is from 0.1 to 500 mM.

Also disclosed herein are methods of use of any of the systems disclosed herein. For example, the methods comprise electrochemical extraction of the target ion from the feed solution.

In some examples, the method comprises: performing adsorption stage by: contacting the feed solution with each of the sorbent chambers (e.g., flowing the feed solution through each of the sorbent chambers) in the absence of an applied electric field (e.g., wherein the circuit is open), thereby contacting the target ion-selective sorbent with the feed solution, such that the target ion-selective sorbent selectively adsorbs the target ion from the feed solution. In some examples, the methods further comprise subsequently stopping the contact with the feed solution. In some examples, the methods further comprise subsequently performing the desorption stage by: contacting each sorbent chamber with the diluate solution (e.g., flowing the diluate solution through each sorbent chamber), contacting each eluate chamber with the receiving solution (e.g., flowing the receiving solution through each eluate chamber), and forming the closed circuit between the pair of terminal electrodes and the power source, such that the pair of terminal electrodes and the power source apply the electrical field across the alternating sorbent chambers and eluate chambers; such that the target ions adsorbed by the target ion-selective sorbent elute from the target ion-selective sorbent to the receiving solution, thereby forming the target ion recovery solution.

In some examples, the method comprises electrochemical lithium extraction from the feed solution.

In some examples, the method comprises: performing adsorption stage by: contacting the feed solution with each of the sorbent chambers (e.g., flowing the feed solution through each of the sorbent chambers) in the absence of an applied electric field (e.g., wherein the circuit is open), thereby contacting the lithium-selective sorbent with the feed solution, such that the lithium-selective sorbent selectively adsorbs lithium from the feed solution; subsequently stopping the contact with the feed solution; and subsequently performing the desorption stage by: contacting each sorbent chamber with the diluate solution (e.g., flowing the diluate solution through each sorbent chamber), contacting each eluate chamber with the receiving solution (e.g., flowing the receiving solution through each eluate chamber), and forming the closed circuit between the pair of terminal electrodes and the power source, such that the pair of terminal electrodes and the power source apply the electrical field across the alternating sorbent chambers and eluate chambers; such that the lithium adsorbed by the lithium-selective sorbent elute from the lithium-selective sorbent to the receiving solution, thereby forming the lithium recovery solution.

In some examples, the methods further comprise collecting the target ion recovery solution (e.g., the lithium recovery solution).

In some examples, the methods further comprise using the target ion (e.g., lithium) from the target ion recovery solution (e.g., the lithium recovery solution), for example in a device or article of manufacture, such as a battery.

Also disclosed herein are systems and/or methods for electrochemical lithium extraction from aqueous solutions, comprising: an adsorption stage using lithium-selective sorbents, such as layered double hydroxides (LDHs), lithium titanate, lithium manganese oxide, or functionalized materials, to selectively adsorb lithium ions; and a desorption stage wherein an electric field is applied to facilitate the desorption of lithium ions into a receiving solution via ion-exchange membranes and/or bipolar membranes. In some examples, anion exchange resins are optionally included in the sorbent chamber to assist in removing competing anions during the adsorption stage. In some examples, the adsorption and desorption phases are explicitly separated, and the electric field is applied only during the desorption phase. In some examples, the process is applicable to solutions with varying TDS levels, ranging from 500 ppm to over 100,000 ppm. In some examples, the lithium adsorption stage utilizes a combination of LDHs, lithium titanate, lithium manganese oxide, and other lithium-selective materials to enhance selectivity and adsorption capacity. In some examples, the system or method comprises any of the systems or methods disclosed herein.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed compositions, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1A. Schematic of mixed sorbent and ion exchange membranes assembly. LiAl-LDH: Lithium Aluminum Layered Double Hydroxide; LTO: lithium titanate; LMO: lithium manganese oxide; AER: anion exchange resin; AEM: anion exchange membrane; CEM: cation exchange membrane. Other combinations of selective sorbents can also be used, including but not limited to, ion-selective cation exchange resin (s-CER) and ion-selective anion exchange resin (s-AER). The same system configuration with different sorbent combinations can achieve different functions. For example, the system can be used for Li extraction, selective separation of other minerals, water softening, desalination, etc., depending on the sorbent combinations.

FIG. 1B. Schematic of mixed sorbent and ion exchange/bipolar membranes assembly. LiAl-LDH: Lithium Aluminum Layered Double Hydroxide; LTO: lithium titanate; LMO: lithium manganese oxide; AER: anion exchange resin; BPM: bipolar membrane; CEM: cation exchange membrane. Other combinations of selective sorbents can also be used, including but not limited to, ion-selective cation exchange resin (s-CER) and ion-selective anion exchange resin (s-AER).

FIG. 2. An example of 3-assembly, 7-chamber stack with electrolysis reactions at terminal electrodes (Desorption phase). C1: terminal cathode chamber; C8: terminal anode chamber; C2, C4, C6: eluate chambers ; C3, C5, C7: sorbent chambers.

FIG. 3. An example of 3-assembly, 7-chamber stack with charge carriers recirculating between two terminal electrodes (Desorption phase). C1: terminal cathode chamber; C7: terminal anode chamber; C2, C4, C6: eluate chambers ; C3, C5, C7: sorbent chambers.

FIG. 4. operational procedure for a two-phase Li extraction process.

FIG. 5. An example three chamber device.

FIG. 6. A photograph of the Electrically Enhanced Lithium Adsorption System (ELiAs) device prototype, illustrating the stacked configuration of chambers and membranes.

FIG. 7. A graph illustrating the effect of current density on the conductivity change of the receiving solution over time using an LDH sorbent, demonstrating electrically driven desorption kinetics.

FIG. 8. A comparative graph illustrating the conductivity change profile of the receiving solution for an ion-exchange sorbent (e.g., LTO or LMO) with and without the addition of an Anion Exchange Resin (AER), demonstrating the importance of the presence of the resin for regeneration.

### DETAILED DESCRIPTION

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

Values can be expressed herein as an “average” value. “Average” generally refers to the statistical mean value.

By “substantially” is meant within 5%, e.g., within 4%, 3%, 2%, or 1%. “Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included. The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB.

Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

Unless otherwise defined, all technical and scientific terms used herein have the same meaning as commonly understood by one of ordinary skill in the art to which this invention belongs.

### Systems and Methods

Described herein are systems and methods for electrochemical extractions of target ions, such as lithium.

For example, disclosed herein are systems for electrochemical extraction of a target ion, the system comprising at least one set of alternating sorbent chambers and eluate chambers defined by a plurality of alternating ion exchange membranes, the plurality of alternating ion exchange membranes being: at least one set of alternating anion exchange membranes and cation exchange membranes, or at least one set of alternating bipolar membranes and cation exchange membranes. Each of the ion exchange membranes forms a boundary between the alternating sorbent chambers and eluate chambers. Each of the ion exchange membranes are in electrochemical and liquid communication with a neighboring pair of sorbent chambers and eluate chambers. Each of the sorbent chambers further contains a target ion-selective sorbent.

In some examples, disclosed herein are systems for electrochemical extraction of a target ion, the system comprising a plurality of alternating sorbent chambers and eluate chambers defined by a plurality of alternating ion exchange membranes, the plurality of alternating ion exchange membranes being: a plurality of alternating anion exchange membranes and cation exchange membranes, or a plurality of alternating bipolar membranes and cation exchange membranes.

The systems further comprise a pair of terminal electrodes and a power source. The pair of terminal electrodes and the power source are configured to apply an electrical field across the alternating sorbent chambers and eluate chambers when a closed circuit is formed between the pair of terminal electrodes and power source.

During operation, the system is configured to sequentially operate an adsorption stage and a desorption stage. During the adsorption stage: the pair of terminal electrodes are not connected to the power source, such that no electrical field is applied across the alternating sorbent chambers and eluate chambers, each sorbent chamber is configured to receive a feed solution comprising the target ion, thereby contacting the target ion-selective sorbent with the feed solution, such that the target ion-selective sorbent selectively adsorbs the target ion from the feed solution. Subsequently, during the desorption stage: each sorbent chamber is configured to receive a diluate solution; each eluate chamber is configured to receive a receiving solution; wherein the diluate solution and receiving solution each have an initially low concentration of the target ion; and a closed circuit is formed between the pair of terminal electrodes and the power source, such that the pair of terminal electrodes and the power source are configured to apply an electrical field across the alternating sorbent chambers and eluate chambers; such that the target ion adsorbed by the target ion-selective sorbent elutes from the target ion-selective sorbent to the receiving solution, thereby forming a target ion recovery solution.

In some examples, each of the cation exchange membranes is a monovalent-selective cation exchange membrane. In some examples, the cation exchange membranes can comprise a Thin-Film Composite (TFC) structure to minimize the thickness of the effective ion exchange layer.

In some examples, the plurality of alternating ion exchange membranes is at least one set of alternating anion exchange membranes and cation exchange membranes, such as a plurality of alternating anion exchange membranes and cation exchange membranes.

In some examples, the target ion comprises an anion, such as chlorides, phosphates, nitrates, sulfates, borates, and/or carbonates.

The target ion can, for example, comprise a critical mineral. Examples of critical minerals include, but are not limited to, aluminum, antimony, arsenic, barite, beryllium, bismuth, calcium, cerium, cesium, chromium, cobalt, copper, dysprosium, erbium, europium, gadolinium, gallium, germanium, graphite, hafnium, holmium, indium, iridium, lanthanum, lithium, lutetium, magnesium, manganese, neodymium, nickel, niobium, palladium, platinum, praseodymium, rhodium, rubidium, ruthenium, samarium, scandium, silicon, tantalum, tellurium, terbium, thulium, tin, titanium, tungsten, vanadium, ytterbium, yttrium, zinc, and zirconium.

In some examples, the target ion comprises a metal, such as an alkaline metal, a transition metal, a rare earth metal, or a combination thereof.

In some examples, the target ion comprises sodium, lithium, calcium, nickel, copper, cobalt, or a combination thereof. In some examples, the target ion comprises sodium, lithium, calcium, or a combination thereof.

In some examples, the target ion comprises lithium.

In some examples, the target ion is lithium and the target ion-selective sorbent is a lithium-selective sorbent.

For example, disclosed herein are systems and methods for electrochemical lithium extraction.

For example, disclosed herein are systems for electrochemical lithium extraction, the systems comprising at least one set of alternating sorbent chambers and eluate chambers defined by at least one set of alternating anion exchange membranes and cation exchange membranes.

Each of the anion exchange membranes and cation exchange membranes form the boundaries between the alternating sorbent chambers and eluate chambers. Each of the anion exchange membranes and cation exchange membranes are in electrochemical and liquid communication with a neighboring pair of sorbent chambers and eluate chambers. Each of the sorbent chambers further contains a lithium-selective sorbent. The systems further comprise a pair of terminal electrodes and a power source. The pair of terminal electrodes and the power source are configured to apply an electrical field across the alternating sorbent chambers and eluate chambers when a closed circuit is formed between the pair of terminal electrodes and power source.

In some examples, disclosed herein are systems for electrochemical lithium extraction, the systems comprising a plurality of alternating sorbent chambers and eluate chambers defined by a plurality of alternating anion exchange membranes and cation exchange membranes. Each of the anion exchange membranes and cation exchange membranes form the boundaries between the alternating sorbent chambers and eluate chambers. Each of the anion exchange membranes and cation exchange membranes are in electrochemical and liquid communication with a neighboring pair of sorbent chambers and eluate chambers. Each of the sorbent chambers further contains a lithium-selective sorbent. The systems further comprise a pair of terminal electrodes and a power source. The pair of terminal electrodes and the power source are configured to apply an electrical field across the plurality of alternating sorbent chambers and eluate chambers when a closed circuit is formed between the pair of terminal electrodes and power source.

During operation, the system is configured to sequentially operate an adsorption stage and a desorption stage. During the adsorption stage: the pair of terminal electrodes are not connected to the power source, such that no electrical field is applied across the alternating sorbent chambers and eluate chambers, each sorbent chamber is configured to receive a feed solution comprising lithium ions, thereby contacting the lithium-selective sorbent with the feed solution, such that the lithium-selective sorbent selectively adsorbs lithium from the feed solution. Subsequently, during the desorption stage: each sorbent chamber is configured to receive a diluate solution; each eluate chamber is configured to receive a receiving solution; wherein the diluate solution and receiving solution each have an initially low concentration of lithium; and a closed circuit is formed between the pair of terminal electrodes and the power source, such that the pair of terminal electrodes and the power source are configured to apply an electrical field across the alternating sorbent chambers and eluate chambers; such that the lithium adsorbed by the lithium-selective sorbent elute from the lithium-selective sorbent to the receiving solution, thereby forming a lithium recovery solution.

The lithium-selective sorbent can comprise any suitable material consistent with the systems and methods described herein. For example, the lithium-selective sorbent can comprise a layered double hydroxide (LDH), lithium titanate (Li₄Ti₅O₁₂, LTO) or its delithiated form (e.g., hydrogen titanate, HTO), lithium manganese oxide (LiMn₂O₄, LMO) or its delithiated form (e.g., hydrogen manganese oxide, HMO), lithium titanium manganate oxides (LTMO) or its delithiated form, other functionalized materials, derivatives thereof (e.g., their modified/doped forms), or a combination thereof.

In some examples, each of the sorbent chambers further comprises an anion exchange resin configured to adsorb competing anions from the feed solution during the adsorption stage, such as chlorides, phosphates, nitrates, sulfates, borates, and/or carbonates.

In some examples, each of the feed solutions, diluate solutions, and/or receiving solutions further comprises a solvent, such as water (e.g., each of the feed solutions, diluate solutions, and/or receiving solutions is an aqueous solution).

In some examples, the feed solution is derived from a natural source or a waste stream. In some examples, the feed solution comprises brackish water, salt lake brine, geothermal brine, seawater, oil and/or gas produced water, mining wastewater, leaching solution in battery recovery, brine from reverse osmosis or other desalination processes, or a combination thereof.

In some examples, the feed solution comprises a brine.

In some examples, the feed solution has a total dissolved solids content of greater than 0 ppm (e.g., 1 or more; 5 or more; 10 or more; 15 or more; 20 or more; 25 or more; 50 or more; 75 or more; 100 or more; 150 or more; 200 or more; 250 or more; 300 or more; 400 or more; 500 or more; 750 or more; 1000 or more; 1250 or more; 1500 or more; 2000 or more; 2500 or more; 3000 or more; 3500 or more; 4000 or more; 4500 or more; 5000 or more; 6000 or more; 7000 or more; 8000 or more; 9000 or more; 10,000 or more; 15,000 or more; 20,000 or more; 25,000 or more; 30,000 or more; 35,000 or more; 40,000 or more; 45,000 or more; 50,000 or more; 60,000 or more; 70,000 or more; 80,000 or more; 90,000 or more; 100,000 or more; 150,000 or more; 200,000 or more; 250,000 or more; or 300,000 or more). In some examples, the feed solution has a total dissolved solids content of 400,000 ppm or less (e.g., 350,000 ppm or less; 300,000 ppm or less; 250,000 ppm or less; 200,000 ppm or less; 150,000 ppm or less; 100,000 ppm or less; 90,000 ppm or less; 80,000 ppm or less; 70,000 ppm or less; 60,000 ppm or less; 50,000 ppm or less; 45,000 ppm or less; 40,000 ppm or less; 35,000 ppm or less; 30,000 ppm or less; 25,000 ppm or less; 20,000 ppm or less; 15,000 ppm or less; 10,000 ppm or less; 9,000 ppm or less; 8,000 ppm or less; 7,000 ppm or less; 6,000 ppm or less; 5,000 ppm or less; 4500 ppm or less; 4000 ppm or less; 3500 ppm or less; 3000 ppm or less; 2500 ppm or less; 2000 ppm or less; 1500 ppm or less; 1250 ppm or less; 1000 ppm or less; 750 ppm or less; 500 ppm or less; 400ppm or less; 300 ppm or less; 250 ppm or less; 200 ppm or less; 150 ppm or less; 100 ppm or less; 75 ppm or less; 50 ppm or less; 25 ppm or less; 20 ppm or less; 15 ppm or less; 10 ppm or less; or 5 ppm or less). The total dissolved solids content of the feed solution can range from any of the minimum values described above to any of the maximum values described above. For example, the feed solution can have a total dissolved solids content of from greater than 0 to 400,000 ppm (e.g., from greater than 0 to 1000 ppm; from 1000 to 400,000 ppm; from greater than 0 to 100 ppm; from 100 to 1000 ppm; from 1000 to 10,000 ppm; from 10,000 to 400,000 ppm; from 10 to 400,000 ppm; from 100 to 400,000 ppm; from 500 to 400,000 ppm; from greater than 0 to 250,000 ppm; from greater than 0 to 100,000 ppm; from 100 to 250,000 ppm;

from 500 to 250,000 ppm; or from 500 to 100,000 ppm). In some examples, the feed solution has a total dissolved solids content of from greater than 0 to 250,000 ppm. In some examples, the feed solution has a total dissolved solids content of from 500 to 100,000 ppm.

In some examples, the diluate solution comprises freshwater.

In some examples, the receiving solution comprises an electrolyte.

In some examples, the concentration of the target ion in the target ion recovery solution is sufficiently high such that subsequent concentration steps are unnecessary.

In some examples, the concentration of the target ion in the target ion recovery solution is 0.1 mM or more (e.g., 0.5 mM or more, 1 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 60 mM or more, 70 mM or more, 80 mM or more, 90 mM or more, 100 mM or more, 125 mM or more, 150 mM or more, 175 mM or more, 200 mM or more, 225 mM or more, 250 mM or more, 275 mM or more, 300 mM or more, 325 mM or more, 350 mM or more, 375 mM or more, 400 mM or more, 425 mM or more, or 450 mM or more). In some examples, the concentration of the target ion in the target ion recovery solution is 500 mM or less (e.g., 475 mM or less, 450 mM or less, 425 mM or less, 400 mM or less, 375 mM or less, 350 mM or less, 325 mM or less, 300 mM or less, 275 mM or less, 250 mM or less, 225 mM or less, 200 mM or less, 175 mM or less, 150 mM or less, 125 mM or less, 100 mM or less, 90 mM or less, 80 mM or less, 70 mM or less, 60 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1 mM or less, or 0.5 mM or less). The concentration of the target ion in the target ion recovery solution can range from any of the minimum values described above to any of the maximum values described above. For example, the concentration of the target ion in the target ion recovery solution can be from 0.1 to 500 mM (e.g., from 0.1 to 250 mM, from 250 to 500 mM, from 0.1 to 1 mM, from 1 to 10 mM, from 10 to 100 mM, from 100 to 500 mM, from 1 to 500 mM, from 5 to 500 mM, from 10 to 500 mM, or from 50 to 500 mM).

In some examples, the target ion is lithium and the concentration of lithium in the lithium recovery solution is sufficiently high such that subsequent concentration steps are unnecessary. In some examples, the target ion is lithium and the concentration of lithium in the lithium recovery solution is 0.1 mM or more (e.g., 0.5 mM or more, 1 mM or more, 1.5 mM or more, 2 mM or more, 2.5 mM or more, 3 mM or more, 3.5 mM or more, 4 mM or more, 4.5 mM or more, 5 mM or more, 6 mM or more, 7 mM or more, 8 mM or more, 9 mM or more, 10 mM or more, 15 mM or more, 20 mM or more, 25 mM or more, 30 mM or more, 35 mM or more, 40 mM or more, 45 mM or more, 50 mM or more, 60 mM or more, 70 mM or more, 80 mM or more, 90 mM or more, 100 mM or more, 125 mM or more, 150 mM or more, 175 mM or more, 200 mM or more, 225 mM or more, 250 mM or more, 275 mM or more, 300 mM or more, 325 mM or more, 350 mM or more, 375 mM or more, 400 mM or more, 425 mM or more, or 450 mM or more). In some examples, the target ion is lithium and the concentration of lithium in the lithium recovery solution is 500 mM or less (e.g., 475 mM or less, 450 mM or less, 425 mM or less, 400 mM or less, 375 mM or less, 350 mM or less, 325 mM or less, 300 mM or less, 275 mM or less, 250 mM or less, 225 mM or less, 200 mM or less, 175 mM or less, 150 mM or less, 125 mM or less, 100 mM or less, 90 mM or less, 80 mM or less, 70 mM or less, 60 mM or less, 50 mM or less, 45 mM or less, 40 mM or less, 35 mM or less, 30 mM or less, 25 mM or less, 20 mM or less, 15 mM or less, 10 mM or less, 9 mM or less, 8 mM or less, 7 mM or less, 6 mM or less, 5 mM or less, 4.5 mM or less, 4 mM or less, 3.5 mM or less, 3 mM or less, 2.5 mM or less, 2 mM or less, 1.5 mM or less, 1 mM or less, or 0.5 mM or less). The concentration of the lithium in the lithium recovery solution can range from any of the minimum values described above to any of the maximum values described above. For example, the concentration of lithium in the lithium recovery solution can be from 0.1 to 500 mM (e.g., from 0.1 to 250 mM, from 250 to 500 mM, from 0.1 to 1 mM, from 1 to 10 mM, from 10 to 100 mM, from 100 to 500 mM, from 1 to 500 mM, from 5 to 500 mM, from 10 to 500 mM, or from 50 to 500 mM).

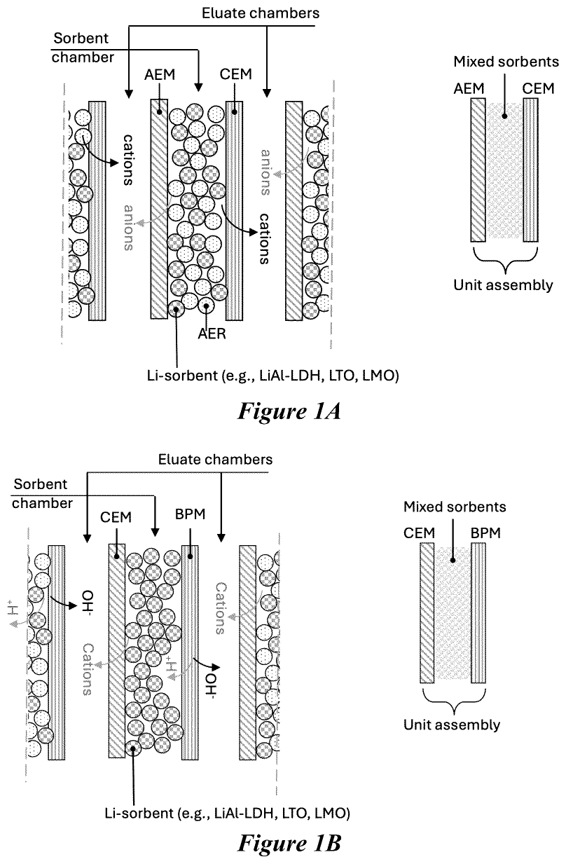

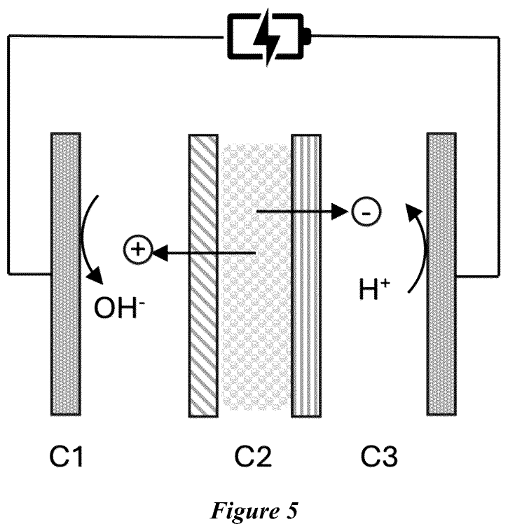

In some examples, the system can comprise any system as shown in FIG. 1A-FIG. 5.

Other combinations of selective sorbents can also be used, including but not limited to, ion-selective cation exchange resin (s-CER) and ion-selective anion exchange resin (s-AER). The same system configuration with different sorbent combinations can achieve different functions. For example, the system can be used for Li extraction, selective separation of other minerals, water softening, desalination, etc., depending on the sorbent combinations.

Also disclosed herein are methods of use of any of the any of the systems disclosed herein.

For example, the methods can comprise electrochemical extraction of the target ion from the feed solution.

Also disclosed herein are methods of electrochemical extraction of a target ion, for example using any of the systems disclosed herein.

In some examples, the method comprises performing adsorption stage by contacting the feed solution with each of the sorbent chambers (e.g., flowing the feed solution through each of the sorbent chambers) in the absence of an applied electric field (e.g., wherein the circuit is open), thereby contacting the target ion-selective sorbent with the feed solution, such that the target ion-selective sorbent selectively adsorbs the target ion from the feed solution. The methods further comprise subsequently stopping the contact with the feed solution. The methods further comprise subsequently performing the desorption stage by: contacting each sorbent chamber with the diluate solution (e.g., flowing the diluate solution through each sorbent chamber), contacting each eluate chamber with the receiving solution (e.g., flowing the receiving solution through each eluate chamber), and forming the closed circuit between the pair of terminal electrodes and the power source, such that the pair of terminal electrodes and the power source apply the electrical field across the alternating sorbent chambers and eluate chambers, such that the target ions adsorbed by the target ion-selective sorbent elute from the target ion-selective sorbent to the receiving solution, thereby forming the target ion recovery solution.

In some examples, the methods further comprise collecting the target ion recovery solution.

In some examples, the concentration of the target ion in the target ion recovery solution is sufficiently high such that subsequent concentration steps are unnecessary.

In some examples, the methods further comprise using the target ion from the target ion recovery solution, for example in a device or article of manufacture, such as a battery.

In some examples, the target ion comprises lithium.

In some examples, the target ion is lithium, and the target ion-selective sorbent is a lithium-selective sorbent.

For example, the methods can comprise electrochemical lithium extraction from the feed solution.

Also disclosed herein are methods of electrochemical lithium extraction, for example using any of the systems disclosed herein.

In some examples, the method comprises performing adsorption stage by contacting the feed solution with each of the sorbent chambers (e.g., flowing the feed solution through each of the sorbent chambers) in the absence of an applied electric field (e.g., wherein the circuit is open), thereby contacting the lithium-selective sorbent with the feed solution, such that the lithium-selective sorbent selectively adsorbs lithium from the feed solution. In some examples, the methods further comprise subsequently stopping the contact with the feed solution. In some examples, the methods further comprise subsequently performing the desorption stage by contacting each sorbent chamber with the diluate solution (e.g., flowing the diluate solution through each sorbent chamber), contacting each eluate chamber with the receiving solution (e.g., flowing the receiving solution through each eluate chamber), and forming the closed circuit between the pair of terminal electrodes and the power source, such that the pair of terminal electrodes and the power source apply the electrical field across the alternating sorbent chambers and eluate chambers, such that the lithium adsorbed by the lithium-selective sorbent elute from the lithium-selective sorbent to the receiving solution, thereby forming the lithium recovery solution.

In some examples, the methods further comprise collecting the lithium recovery solution. In some examples, the concentration of lithium in the lithium recovery solution is sufficiently high such that subsequent concentration steps are unnecessary.

In some examples, the methods further comprise using the lithium from the lithium recovery solution, for example in a device or article of manufacture, such as a battery.

Also disclosed herein are systems and methods for electrochemical lithium extraction from aqueous solutions, comprising: an adsorption stage using lithium-selective sorbents, such as layered double hydroxides (LDHs), lithium titanate, lithium manganese oxide, or functionalized materials, to selectively adsorb lithium ions; and a desorption stage wherein an electric field is applied to facilitate the desorption of lithium ions into a receiving solution via ion-exchange membranes and/or bipolar membranes. In some examples, anion exchange resins are optionally included in the sorbent chamber to assist in removing competing anions during the adsorption stage. In some examples, the adsorption and desorption phases are explicitly separated, and the electric field is applied only during the desorption phase. In some examples, the process is applicable to solutions with varying TDS levels, ranging from 500 ppm to over 100,000 ppm. In some examples, the lithium adsorption stage utilizes a combination of LDHs, lithium titanate, lithium manganese oxide, and other lithium-selective materials to enhance selectivity and adsorption capacity.

A number of embodiments of the invention have been described. Nevertheless, it will be understood that various modifications may be made without departing from the spirit and scope of the invention. Accordingly, other embodiments are within the scope of the following claims. The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

This disclosure relates to technologies for extracting lithium and/or other metals, specifically systems and methods for electrochemically-enhanced lithium extraction designed to efficiently recover lithium ions from brines or other aqueous solutions. For example, this disclosure relates to lithium extraction technologies, specifically systems and methods for electrochemical lithium extraction designed to efficiently recover lithium ions from brines or other aqueous solutions. The process leverages selective sorbents and sequential application of an electric field to address equilibrium limitations and energy inefficiencies common in conventional methods.

Lithium is a critical material for batteries and renewable energy storage systems. Brines, including those with high total dissolved solids (TDS) such as geothermal waters, oilfield brines, and salt lakes, represent significant untapped lithium resources. However, brines with moderate or low TDS also present opportunities for lithium extraction. Existing technologies face two major challenges:

1. Equilibrium Limitations in Lithium Desorption: Conventional desorption methods, such as using freshwater to elute lithium-laden LDH adsorbents, often yield dilute lithium streams due to equilibrium constraints, necessitating additional concentration steps.

2. Operational Limitations in Continuous EDI: Conventional Electrodeionization (EDI) processes operate continuously, which leads to indiscriminate removal of cations, making them inefficient for lithium-selective recovery. Furthermore, EDI systems rely on ion-exchange membranes paired with traditional ion-exchange resins rather than lithium-selective sorbents, limiting their utility for selective lithium recovery.

Described herein are systems and methods that distinctly separate adsorption and desorption operations, combining lithium-selective sorbents and intermittent electric fields to overcome these limitations. Additionally, it enables the generation of a high-concentration lithium stream, significantly reducing the need for further concentration steps.

Described herein are systems and methods for electrochemical lithium recovery. The systems and methods can, for example, comprise an adsorption phase and a desorption phase.

Adsorption Phase (No Electric Field): Lithium-selective sorbents, such as Layered Double Hydroxides (LDHs), lithium titanate (Li₄Ti₅O₁₂, LTO), lithium manganese oxide (LiMn₂O₄, LMO), or their modified/doped and/or delithiated forms (e.g., hydrogen titanate (HTO), hydrogen manganese oxide (HMO), etc.) and other functionalized materials, selectively adsorb lithium ions from the feed solution. Optionally, anion exchange resins (AERs) can be included in the sorbent chamber to assist in removing anions (e.g., competing anions) such as chloride, sulfate, or carbonate. The electric circuit remains disconnected during this phase, and no external field is applied.

Desorption Phase (Electric Field Applied): Freshwater or a low-concentration solution is introduced into the system, and an electric field is applied to elute lithium ions from the sorbents into a receiving solution. This is achieved via electrodialysis using ion-exchange membranes to separate chambers, maintaining low lithium concentration in the sorbent chamber and avoiding equilibrium limitations. The process results in a high-concentration lithium stream in the receiving solution, which is advantageous for downstream processing.

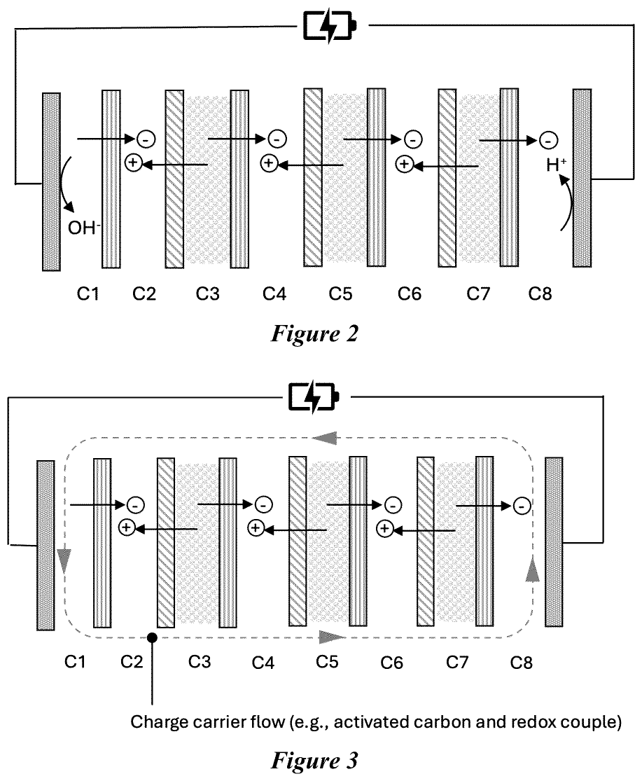

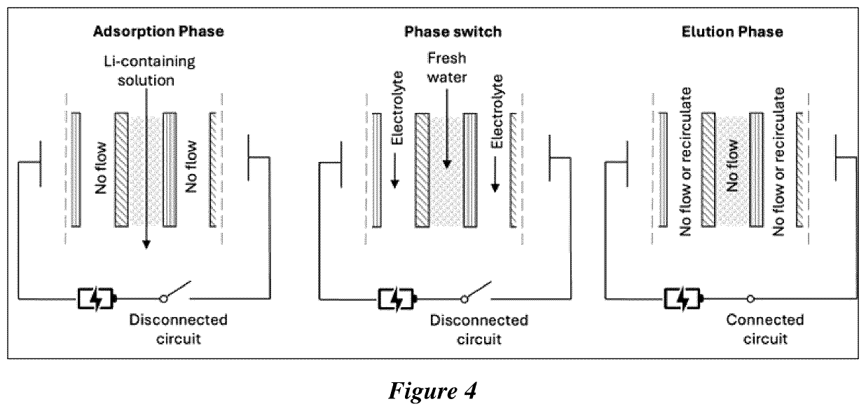

FIG. 1A and FIG. 1B show example schematics of a unit assembly, FIG. 2 and FIG. 3 show example stacked configurations showing different approaches of maintaining charge neutrality in terminal chambers, and FIG. 4 shows a schematic diagram for the operational procedure.

Key Differences from Conventional EDI:

1. Purpose: Conventional EDI is designed for continuous deionization of water, whereas the process described herein explicitly targets selective ion extraction, such as lithium extraction. The process described herein works for all types of selective ion separation using adsorption, where different types of sorbents will be used for different target ions.

2. Sorbents: Instead of ion-exchange resins, the process described herein employs lithium-selective sorbents like LDHs, LTO, HTO, HMO, and LMO for high specificity. In some examples, instead of ion-exchange resins, the process described herein employs lithium-selective sorbents like LDHs, LTO, and LMO for high specificity. The optional inclusion of AERs enhances functionality.

3. Operation: Conventional EDI operates continuously, while the system described herein is explicitly separated into distinct adsorption and desorption phases (refer to FIG. 4).

4. Output: The systems and methods described herein produce a high-concentration lithium stream, reducing the need for additional concentration steps in downstream processes.

### Advantages Include, but are Not Limited To:

1. Selective Lithium Recovery: By separating adsorption and desorption phases, the system achieves high lithium selectivity, avoiding the indiscriminate removal of all cations.

2. High-Concentration Lithium Stream: The desorption phase produces a concentrated lithium solution, simplifying subsequent processing.

3. Energy Efficiency: The electric field is applied only during the desorption phase, minimizing energy consumption compared to continuous EDI processes. Depending on the adsorbents integrated to the system, the process can also be used for extracting metals other than lithium.
4. Broad Applicability: The process can be applied to high-, medium-, and low-TDS brines, as well as other aqueous solutions with diverse compositions.
5. Improved Lithium Recovery: Continuous removal of lithium ions during desorption prevents equilibrium limitations, ensuring high recovery efficiency.

### Example 2

Described herein is a Lithium adsorption and desorption system.

An objective is to selectively extract lithium ions from a feed solution and ensure continuous recovery into a receiving solution.
Unit Assembly: Refer to FIG. 1A and FIG. 1B for the structure of a unit assembly. Each unit comprises chambers separated by ion-exchange membranes (e.g., one CEM and one AEM, or one CEM and one BPM). Lithium-selective sorbents are packed into specific chambers (e.g., C3, C5, C7 in FIG. 2 and FIG. 3). The sorbent chamber may also contain anion exchange resins (AERs).
Stack Configurations:
   FIG. 2: This stacked configuration achieves charge neutrality in the terminal electrodes by relying on electrolysis of water. Protons and hydroxide ions are generated to balance the charges during the process.
   FIG. 3: This alternative configuration maintains charge neutrality in the terminal electrodes by circulating a charge-carrying stream through the terminal chambers, creating a recirculating loop for balancing ions.
Operational Procedure:
   Adsorption Phase (FIG. 4, Step 1): The feed solution flows through the sorbent chamber (e.g., C1 in FIG. 1A and FIG. 1B), where lithium ions are selectively adsorbed onto materials like LDHs, LTO, or LMO. If AERs are present, they assist in removing anions such as sulfate or carbonate. No electric field is applied, and competing ions remain in solution.
   Desorption Phase (FIG. 4, Step 2): The feed solution is replaced with freshwater or a dilute solution of electrolytes.

In system version 1 with AEM (FIG. 1A), an electric field is applied across the system to drive desorbed lithium ions from the sorbent chamber through ion-exchange membranes into the receiving solution. This maintains low lithium concentrations in the sorbent chamber, avoiding equilibrium limitations and ensuring efficient desorption. The receiving solution achieves a high lithium concentration, simplifying downstream processing.

In system version 2 with BPM (FIG. 1B), an electric field is applied across the system to split water in the BPM and produce protons (H⁺) and hydroxide ions (OH⁻). The protons enter the sorbent chambers and promote the release of lithium ions from sorbents via ion exchange. The released lithium ions pass through the CEM under the electric field to enter the receiving solution, while the hydroxide ions generated from the BPM also enter the receiving solution to maintain charge neutrality.

In both versions, monovalent-selective CEMs can be used ensure that divalent ions such as calcium and magnesium are excluded from the eluate stream, enhancing lithium purity.

### Example 3

For example, disclosed herein are systems for electrochemical lithium extraction (e.g., electrochemically enhanced lithium extraction) from aqueous solutions, comprising: an adsorption stage using lithium-selective sorbents, such as layered double hydroxides, lithium titanate or its delithiated form, lithium manganese oxide or its delithiated form, or functionalized materials, to selectively adsorb lithium ions; and a desorption stage wherein an electric field is applied to facilitate the desorption of lithium ions into a receiving solution via ion-exchange membranes.

In some examples, anion exchange resins are optionally included in the sorbent chamber to assist in removing competing anions during the adsorption phase.

In some examples, the adsorption and desorption phases are explicitly separated, and the electric field is applied only during the desorption phase.

In some examples, the process is applicable to solutions with varying TDS levels, ranging from 500 ppm to over 100,000 ppm.

In some examples, the lithium adsorption stage utilizes a combination of LDHs, lithium titanate, lithium manganese oxide, and other lithium-selective materials to enhance selectivity and adsorption capacity.

Described herein are scalable, energy-efficient, and selective systems and methods for lithium recovery from a wide range of aqueous solutions. By addressing the limitations of equilibrium constraints and energy inefficiencies while enabling the generation of a high-concentration lithium stream, this system and methods represents a significant advancement in lithium extraction technology.

The systems and methods described herein relate to lithium extraction technologies, specifically systems and methods for electrochemical lithium extraction designed to efficiently recover lithium ions from brines or other aqueous solutions. The systems and methods leverage selective sorbents and sequential application of an electric field to address equilibrium limitations and energy inefficiencies common in conventional methods.

The systems and methods described herein introduces a two-phase electrochemical lithium extraction method that can utilize the most commonly used LDH adsorbents but overcome its limitation of low equilibrium Li concentration, which will either reduce the use of freshwater for desorption or remove the need for additional concentration step. The systems and methods described herein integrate three functionalities into one system/method: lithium desorption, further purification of lithium (with monovalent-selective CEMs), and concentration of lithium solution. These functionalities are typically achieved using three different unit processes in conventional lithium processing treatment trains.

Compared to current technologies, such as conventional LDH adsorption, the systems and methods described herein offer significant improvements. Compared to current technologies, such as electro-sorption using battery electrode materials, they are expensive compared to LDH adsorption, and electrode material stability is a key limitation, which can be overcome by the systems and methods described herein.

### Example 4

Sorbent Mechanisms and Embodiments. The systems disclosed herein can operate via two distinct electrochemical mechanisms depending on the sorbent selected:
1. Co-Intercalation Embodiment (e.g., LDH): In examples utilizing Layered Double Hydroxides (LDH), the sorbent captures lithium via co-intercalation of the cation (Li⁺) and a counter-anion (e.g., Cl⁻). As such, the applied electric field during desorption actively drives both the lithium and the anion out of the sorbent structure, overcoming equilibrium limitations.
2. Water-Splitting Ion-Exchange Embodiment (e.g., LTO/LMO): In examples utilizing Lithium Titanate (LTO) or Lithium Manganese Oxide (LMO), the sorbent operates via ion exchange (Li⁺⇄H⁺). Unlike LDH, these sorbents require an in-situ source of protons for regeneration. In these examples, the sorbent chamber comprises a physical mixture of the lithium-selective sorbent and an electrically conductive Anion Exchange Resin (AER) or polymer. This mixture forms bipolar interfaces where, under the applied electric field, water splitting occurs to generate the protons (H⁺) required to displace lithium from the sorbent. Without this specific mixture, the ion-exchange sorbents are electrically inactive in the desorption phase.

### Example 5

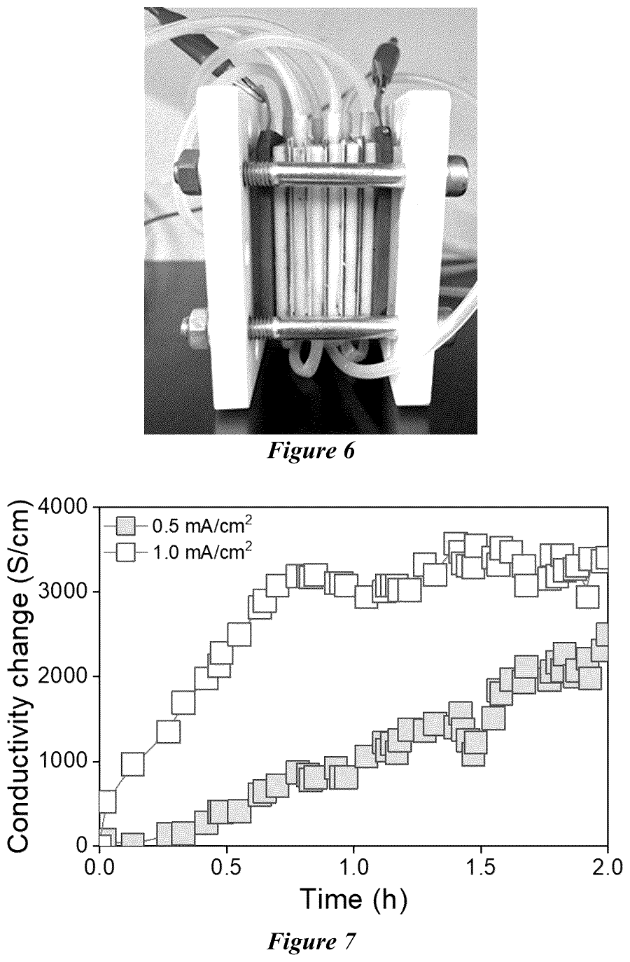

Prototype Configuration: A reduction to practice of the systems disclosed herein is illustrated in FIG. 6, showing the assembled ELiAS device comprising alternating sorbent and eluate chambers clamped between terminal electrodes. This prototype was utilized for the data collection described below.

Evidence of Electrically Driven Desorption (LDH): to demonstrate that the desorption is actively driven by the electric field rather than passive washing, the system (loaded with LDH sorbent) was operated at varying current densities. FIG. 7 illustrates the conductivity of the receiving solution over time. The data shows a direct correlation between current density and desorption rate; the trial at 1.0 mA/cm² exhibited a significantly faster rise in conductivity and reached a higher steady-state value compared to 0.5mA/cm². This confirms the system utilizes electromigration to accelerate kinetics and shift equilibrium.

Selectivity and High Concentration: The system was tested against a mixed brine feed containing competing Sodium (Na⁺) ions. The system achieved a lithium concentration over 200 mg/L in the receiving solution and a separation factor of Lithium vs. Sodium over 350. This high performance allows for the production of a concentrated, high-purity lithium stream, potentially reducing the need for subsequent concentration stages.

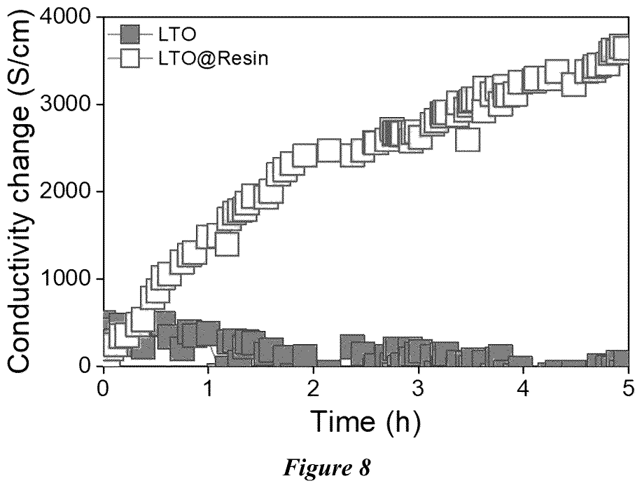

Importance of the Resin Mixture (LTO/LMO): To validate the mechanism of the LTO/LMO embodiment, a comparative test was conducted as shown in FIG. 8. When LTO sorbent was used without an anion exchange polymer, the conductivity of the receiving solution remained flat upon application of current, indicating no lithium release. In contrast, when the same sorbent was mixed with an anion exchange polymer, a rapid increase in conductivity was observed, confirming that the addition of the ion-exchange polymer is important for creating the water-splitting interfaces necessary to regenerate ion-exchange sorbents.

### EXEMPLARY ASPECTS

In view of the described compositions, devices, systems, and methods, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A system for electrochemical extraction of a target ion, the system comprising:
at least one set of alternating sorbent chambers and eluate chambers defined by a plurality of alternating ion exchange membranes, the plurality of alternating ion exchange membranes being: at least one set of alternating anion exchange membranes and cation exchange membranes, or at least one set of alternating bipolar membranes and cation exchange membranes;
   wherein each of the ion exchange membranes forms a boundary between the alternating sorbent chambers and eluate chambers;
   wherein each of the ion exchange membranes are in electrochemical and liquid communication with a neighboring pair of sorbent chambers and eluate chambers;
   wherein each of the sorbent chambers further contains a target ion-selective sorbent;
a pair of terminal electrodes; and
a power source;
   wherein the pair of terminal electrodes and the power source are configured to apply an electrical field across the alternating sorbent chambers and eluate chambers when a closed circuit is formed between the pair of terminal electrodes and power source;
wherein, during operation, the system is configured to sequentially operate an adsorption stage and a desorption stage;
wherein, during the adsorption stage:
   the pair of terminal electrodes are not connected to the power source, such that no electrical field is applied across the alternating sorbent chambers and eluate chambers,
   each sorbent chamber is configured to receive a feed solution comprising the target ion, thereby contacting the target ion-selective sorbent with the feed solution, such that the target ion-selective sorbent selectively adsorbs the target ion from the feed solution;
subsequently, during the desorption stage:
   each sorbent chamber is configured to receive a diluate solution;
   each eluate chamber is configured to receive a receiving solution;
   wherein the diluate solution and receiving solution each have an initially low concentration of the target ion;
   a closed circuit is formed between the pair of terminal electrodes and the power source, such that the pair of terminal electrodes and the power source are configured to apply an electrical field across the alternating sorbent chambers and eluate chambers;
   such that the target ion adsorbed by the target ion-selective sorbent elutes from the target ion-selective sorbent to the receiving solution, thereby forming a target ion recovery solution.

Example 2: The system of any example herein, particularly example 1, wherein each of the cation exchange membranes is a monovalent-selective cation exchange membrane.

Example 3: The system of any example herein, particularly example 1 or example 2, wherein the plurality of alternating ion exchange membranes is at least one set of alternating anion exchange membranes and cation exchange membranes, such as a plurality of alternating anion exchange membranes and cation exchange membranes.

Example 4: The system of any example herein, particularly examples 1-3, wherein the target ion comprises an anion, such as chlorides, phosphates, nitrates, sulfates, borates, and/or carbonates.

Example 5: The system of any example herein, particularly examples 1-4, wherein the target ion comprises a critical mineral.

Example 6: The system of any example herein, particularly examples 1-5, wherein the target ion comprises a metal, such as an alkaline metal, a transition metal, a rare earth metal, or a combination thereof.

Example 7: The system of any example herein, particularly examples 1-6, wherein the target ion comprises sodium, lithium, calcium, nickel, copper, cobalt, or a combination thereof.

Example 8: The system of any example herein, particularly examples 1-7, wherein the target ion comprises sodium, lithium, calcium, or a combination thereof.

Example 9: The system of any example herein, particularly examples 1-8, wherein the target ion comprises lithium.

Example 10: The system of any example herein, particularly examples 1-9, wherein the target ion is lithium, and the target ion-selective sorbent is a lithium-selective sorbent.

Example 11: A system for electrochemical lithium extraction, the system comprising:
at least one set of alternating sorbent chambers and eluate chambers defined by at least one set of alternating anion exchange membranes and cation exchange membranes;
   wherein each of the anion exchange membranes and cation exchange membranes forms a boundary between the alternating sorbent chambers and eluate chambers;
   wherein each of the anion exchange membranes and cation exchange membranes are in electrochemical and liquid communication with a neighboring pair of sorbent chambers and eluate chambers;
   wherein each of the sorbent chambers further contains a lithium-selective sorbent;
a pair of terminal electrodes; and
a power source;
   wherein the pair of terminal electrodes and the power source are configured to apply an electrical field across the alternating sorbent chambers and eluate chambers when a closed circuit is formed between the pair of terminal electrodes and power source;
wherein, during operation, the system is configured to sequentially operate an adsorption stage and a desorption stage;
wherein, during the adsorption stage:
   the pair of terminal electrodes are not connected to the power source, such that no electrical field is applied across the alternating sorbent chambers and eluate chambers,
   each sorbent chamber is configured to receive a feed solution comprising lithium, thereby contacting the lithium-selective sorbent with the feed solution, such that the lithium-selective sorbent selectively adsorbs lithium from the feed solution;
subsequently, during the desorption stage:
   each sorbent chamber is configured to receive a diluate solution;
   each eluate chamber is configured to receive a receiving solution;
   wherein the diluate solution and receiving solution each have an initially low concentration of lithium;
   a closed circuit is formed between the pair of terminal electrodes and the power source, such that the pair of terminal electrodes and the power source are configured to apply an electrical field across the alternating sorbent chambers and eluate chambers;
   such that the lithium adsorbed by the lithium-selective sorbent elutes from the lithium-selective sorbent to the receiving solution, thereby forming a lithium recovery solution

Example 12: The system of any example herein, particularly example 11, wherein the lithium-selective sorbent comprises a layered double hydroxide (LDH), lithium titanate (Li₄Ti₅O₁₂, LTO) or its delithiated form (e.g., hydrogen titanate, HTO), lithium manganese oxide (LiMn₂O4, LMO) or its delithiated form (e.g., hydrogen manganese oxide, HMO), lithium titanium manganate oxides (LTMO) or its delithiated form, other functionalized materials, derivatives thereof (e.g., their modified/doped forms), or a combination thereof.

Example 13: The system of any example herein, particularly examples 1-12, wherein each of the sorbent chambers further comprises an anion exchange resin configured to adsorb competing anions from the feed solution during the adsorption stage, such as chlorides, phosphates, nitrates, sulfates, borates, and/or carbonates.

Example 14: The system of any example herein, particularly examples 1-13, wherein each of the feed solutions, diluate solutions, and/or receiving solutions further comprises a solvent, such as water (e.g., each of the feed solutions, diluate solutions, and/or receiving solutions is an aqueous solution).

Example 15: The system of any example herein, particularly examples 1-14, wherein the feed solution is derived from a natural source or a waste stream.

Example 16: The system of any example herein, particularly examples 1-15, wherein the feed solution comprises brackish water, salt lake brine, geothermal brine, seawater, oil and/or gas produced water, mining wastewater, leaching solution in battery recovery, brine from reverse osmosis or other desalination processes, or a combination thereof.

Example 17: The system of any example herein, particularly examples 1-16, wherein the feed solution comprises a brine.

Example 18: The system of any example herein, particularly examples 1-17, wherein the feed solution has a total dissolved solids content of from greater than 0 to 400,000 ppm, such as from greater than 0 to 250,000 ppm.

Example 19: The system of any example herein, particularly examples 1-18, wherein the feed solution has a total dissolved solids content of from 500 to 100,000 ppm.

Example 20: The system of any example herein, particularly examples 1-19, wherein the diluate solution comprises freshwater.

Example 21: The system of any example herein, particularly examples 1-20, wherein the receiving solution comprises an electrolyte.

Example 22: The system of any example herein, particularly examples 1-21, wherein the concentration of the target ion (e.g., lithium) in the target ion recovery solution (e.g., lithium recovery solution) is sufficiently high such that subsequent concentration steps are unnecessary. Example 23: The system of any example herein, particularly examples 1-22, wherein the concentration of the target ion (e.g., lithium) in the target ion recovery solution (e.g., lithium recovery solution) is from 0.1 to 500 mM.

Example 24: A method of use of the system of any example herein, particularly examples 1-23.

Example 25: The method of any example herein, particularly example 24, wherein the method comprises electrochemical extraction of the target ion from the feed solution.

Example 26: The method of any example herein, particularly examples 24-25, wherein the method comprises:
performing adsorption stage by:
   contacting the feed solution with each of the sorbent chambers (e.g., flowing the feed solution through each of the sorbent chambers) in the absence of an applied electric field (e.g., wherein the circuit is open),
   thereby contacting the target ion-selective sorbent with the feed solution, such that the target ion-selective sorbent selectively adsorbs the target ion from the feed solution;
subsequently stopping the contact with the feed solution; and
subsequently performing the desorption stage by:
   contacting each sorbent chamber with the diluate solution (e.g., flowing the diluate solution through each sorbent chamber),
   contacting each eluate chamber with the receiving solution (e.g., flowing the receiving solution through each eluate chamber), and
   forming the closed circuit between the pair of terminal electrodes and the power source, such that the pair of terminal electrodes and the power source apply the electrical field across the alternating sorbent chambers and eluate chambers;
   such that the target ions adsorbed by the target ion-selective sorbent elute from the target ion-selective sorbent to the receiving solution, thereby forming the target ion recovery solution.

Example 27: The method of any example herein, particularly examples 24-26, wherein each of the cation exchange membranes is a monovalent-selective cation exchange membrane.

Example 28: The method of any example herein, particularly examples 24-27, wherein the plurality of alternating ion exchange membranes is at least one set of alternating anion exchange membranes and cation exchange membranes, such as a plurality of alternating anion exchange membranes and cation exchange membranes.

Example 29: The method of any example herein, particularly examples 24-28, wherein the target ion comprises an anion, such as chlorides, phosphates, nitrates, sulfates, borates, and/or carbonates.

Example 30: The method of any example herein, particularly examples 24-29, wherein the target ion comprises a critical mineral.

Example 31: The method of any example herein, particularly examples 24-30, wherein the target ion comprises a metal, such as an alkaline metal, a transition metal, a rare earth metal, or a combination thereof.

Example 32: The method of any example herein, particularly examples 24-31, wherein the target ion comprises sodium, lithium, calcium, nickel, copper, cobalt, or a combination thereof.

Example 33: The method of any example herein, particularly examples 24-32, wherein the target ion comprises sodium, lithium, calcium, or a combination thereof.

Example 34: The method of any example herein, particularly examples 24-33, wherein the target ion comprises lithium.

Example 35: The method of any example herein, particularly examples 24-34, wherein the target ion is lithium, and the target ion-selective sorbent is a lithium-selective sorbent.

Example 36: The method of any example herein, particularly examples 34-35, wherein the method comprises electrochemical lithium extraction from the feed solution.

Example 37: The method of any example herein, particularly examples 34-36, wherein the method comprises:
performing adsorption stage by:
   contacting the feed solution with each of the sorbent chambers (e.g., flowing the feed solution through each of the sorbent chambers) in the absence of an applied electric field (e.g., wherein the circuit is open),
   thereby contacting the lithium-selective sorbent with the feed solution, such that the lithium-selective sorbent selectively adsorbs lithium from the feed solution;
subsequently stopping the contact with the feed solution; and
subsequently performing the desorption stage by:
   contacting each sorbent chamber with the diluate solution (e.g., flowing the diluate solution through each sorbent chamber),
   contacting each eluate chamber with the receiving solution (e.g., flowing the receiving solution through each eluate chamber), and
   forming the closed circuit between the pair of terminal electrodes and the power source, such that the pair of terminal electrodes and the power source apply the electrical field across the alternating sorbent chambers and eluate chambers;
   such that the lithium adsorbed by the lithium-selective sorbent elute from the lithium-selective sorbent to the receiving solution, thereby forming the lithium recovery solution.

Example 38: The method of any example herein, particularly example 37, wherein the lithium-selective sorbent comprises a layered double hydroxide (LDH), lithium titanate (Li₄Ti₅O₁₂, LTO) or its delithiated form (e.g., hydrogen titanate, HTO), lithium manganese oxide (LiMn₂O₄, LMO) or its delithiated form (e.g., hydrogen manganese oxide, HMO), lithium titanium manganate oxides (LTMO) or its delithiated form, other functionalized materials, derivatives thereof (e.g., their modified/doped forms), or a combination thereof.

Example 39: The method of any example herein, particularly examples 24-38, wherein each of the sorbent chambers further comprises an anion exchange resin configured to adsorb competing anions from the feed solution during the adsorption stage, such as chlorides, phosphates, nitrates, sulfates, borates, and/or carbonates.

Example 40: The method of any example herein, particularly examples 24-39, wherein each of the feed solutions, diluate solutions, and/or receiving solutions further comprises a solvent, such as water (e.g., each of the feed solutions, diluate solutions, and/or receiving solutions is an aqueous solution).

Example 41: The method of any example herein, particularly examples 24-40, wherein the feed solution is derived from a natural source or a waste stream.

Example 42: The method of any example herein, particularly examples 24-41, wherein the feed solution comprises brackish water, salt lake brine, geothermal brine, seawater, oil and/or gas produced water, mining wastewater, leaching solution in battery recovery, brine from reverse osmosis or other desalination processes, or a combination thereof.

Example 43: The method of any example herein, particularly examples 24-42, wherein the feed solution comprises a brine.

Example 44: The method of any example herein, particularly examples 24-43, wherein the feed solution has a total dissolved solids content of greater than 0 to 400,000 ppm, such as from greater than 0 to 250,000 ppm.

Example 45: The method of any example herein, particularly examples 24-44, wherein the feed solution has a total dissolved solids content of from 500 to 100,000 ppm.

Example 46: The method of any example herein, particularly examples 24-45, wherein the diluate solution comprises freshwater.

Example 47: The method of any example herein, particularly examples 24-46, wherein the receiving solution comprises an electrolyte.

Example 48: The method of any example herein, particularly examples 24-47, wherein the concentration of the target ion (e.g., lithium) in the target ion recovery solution (e.g., the lithium recovery solution) is sufficiently high such that subsequent concentration steps are unnecessary.

Example 49: The method of any example herein, particularly examples 24-48, wherein the concentration of the target ion (e.g., lithium) in the target ion recovery solution (e.g., the lithium recovery solution) is from 0.1 to 500 mM.

Example 50: The method of any example herein, particularly examples 24-49, further comprising collecting the target ion recovery solution (e.g., the lithium recovery solution).

Example 51: The method of any example herein, particularly examples 24-50, further comprising using the target ion (e.g., lithium) from the target ion recovery solution (e.g., the lithium recovery solution), for example in a device or article of manufacture, such as a battery.

Example 52: A system or method for electrochemical lithium extraction from aqueous solutions, comprising:
an adsorption stage using lithium-selective sorbents, such as layered double hydroxides (LDHs), lithium titanate, lithium manganese oxide, or functionalized materials, to selectively adsorb lithium ions; and
a desorption stage wherein an electric field is applied to facilitate the desorption of lithium ions into a receiving solution via ion-exchange membranes and/or bipolar membranes.

Example 53: The system or method of any example herein, particularly example 52, wherein anion exchange resins are optionally included in the sorbent chamber to assist in removing competing anions during the adsorption stage.

Example 54: The system or method of any example herein, particularly example 52, wherein the adsorption and desorption phases are explicitly separated, and the electric field is applied only during the desorption phase.

Example 55: The system or method of any example herein, particularly example 52, wherein the process is applicable to solutions with varying TDS levels, ranging from 500 ppm to over 100,000 ppm.

Example 56: The system or method of any example herein, particularly example 52,wherein the lithium adsorption stage utilizes a combination of LDHs, lithium titanate, lithium manganese oxide, and other lithium-selective materials to enhance selectivity and adsorption capacity.

Example 57: The system or method of any example herein, particularly examples 52-56,wherein the system or method comprises the system or method of any example herein, particularly examples 1-51.

Other advantages which are obvious and which are inherent to the invention will be evident to one skilled in the art. It will be understood that certain features and sub-combinations are of utility and may be employed without reference to other features and sub-combinations.

This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The compositions, systems, and methods of the appended claims are not limited in scope by the specific compositions, system, and methods described herein, which are intended as illustrations of a few aspects of the claims and any methods that are functionally equivalent are intended to fall within the scope of the claims. Various modifications of the compositions, systems, and methods in addition to those shown and described herein are intended to fall within the scope of the appended claims. Further, while only certain representative composition elements, system elements, and method steps disclosed herein are specifically described, other combinations of the composition elements, system elements, and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed:

1. A system for electrochemical extraction of a target ion, the system comprising:
at least one set of alternating sorbent chambers and eluate chambers defined by a plurality of alternating ion exchange membranes, the plurality of alternating ion exchange membranes being: at least one set of alternating anion exchange membranes and cation exchange membranes, or at least one set of alternating bipolar membranes and cation exchange membranes;
wherein each of the ion exchange membranes forms a boundary between the alternating sorbent chambers and eluate chambers;
wherein each of the ion exchange membranes are in electrochemical and liquid communication with a neighboring pair of sorbent chambers and eluate chambers;
wherein each of the sorbent chambers further contains a target ion-selective sorbent;
a pair of terminal electrodes; and
a power source;
wherein the pair of terminal electrodes and the power source are configured to apply an electrical field across the alternating sorbent chambers and eluate chambers when a closed circuit is formed between the pair of terminal electrodes and power source;
wherein, during operation, the system is configured to sequentially operate an adsorption stage and a desorption stage;
wherein, during the adsorption stage:
the pair of terminal electrodes are not connected to the power source, such that no electrical field is applied across the alternating sorbent chambers and eluate chambers,
each sorbent chamber is configured to receive a feed solution comprising the target ion, thereby contacting the target ion-selective sorbent with the feed solution, such that the target ion-selective sorbent selectively adsorbs the target ion from the feed solution;
subsequently, during the desorption stage:
each sorbent chamber is configured to receive a diluate solution;
each eluate chamber is configured to receive a receiving solution;
wherein the diluate solution and receiving solution each have an initially low concentration of the target ion;
a closed circuit is formed between the pair of terminal electrodes and the power source, such that the pair of terminal electrodes and the power source are configured to apply an electrical field across the alternating sorbent chambers and eluate chambers;
such that the target ion adsorbed by the target ion-selective sorbent elutes from the target ion-selective sorbent to the receiving solution, thereby forming a target ion recovery solution.

2. The system of claim 1, wherein each of the cation exchange membranes is a monovalent-selective cation exchange membrane.

3. The system of claim 1, wherein the plurality of alternating ion exchange membranes is at least one set of alternating anion exchange membranes and cation exchange membranes.

4. The system of claim 1, wherein the target ion comprises an anion.

5. The system of claim 1, wherein the target ion comprises a metal.

6. The system of claim 1, wherein the target ion comprises sodium, lithium, calcium, nickel, copper, cobalt, or a combination thereof.

7. The system of claim 1, wherein the target ion comprises sodium, lithium, calcium, or a combination thereof.

8. The system of claim 1, wherein the target ion is lithium, and the target ion-selective sorbent is a lithium-selective sorbent.

9. The system of claim 8, wherein the lithium-selective sorbent comprises a layered double hydroxide (LDH), lithium titanate (Li₄Ti₅O₁₂, LTO) or its delithiated form (e.g., hydrogen titanate, HTO), lithium manganese oxide (LiMn₂O₄, LMO) or its delithiated form (e.g., hydrogen manganese oxide, HMO), lithium titanium manganate oxides (LTMO) or its delithiated form, other functionalized materials, derivatives thereof (e.g., their modified/doped forms), or a combination thereof.

10. The system of claim 1, wherein each of the sorbent chambers further comprises an anion exchange resin configured to adsorb competing anions from the feed solution during the adsorption stage.

11. The system of claim 1, wherein each of the feed solutions, diluate solutions, and/or receiving solutions is an aqueous solution.

12. The system of claim 1, wherein the feed solution is derived from a natural source or a waste stream.

13. The system of claim 1, wherein the feed solution comprises brackish water, salt lake brine, geothermal brine, seawater, oil and/or gas produced water, mining wastewater, leaching solution in battery recovery, brine from reverse osmosis or other desalination processes, or a combination thereof.

14. The system of claim 1, wherein the diluate solution comprises freshwater.

15. The system of claim 1, wherein the receiving solution comprises an electrolyte.

16. The system of claim 1, wherein the concentration of the target ion in the target ion recovery solution is sufficiently high such that subsequent concentration steps are unnecessary.

17. The system of claim 1, wherein the concentration of the target ion in the target ion recovery solution is from 0.1 to 500 mM.

18. A system for electrochemical lithium extraction, the system comprising:
at least one set of alternating sorbent chambers and eluate chambers defined by at least one set of alternating anion exchange membranes and cation exchange membranes;
wherein each of the anion exchange membranes and cation exchange membranes forms a boundary between the alternating sorbent chambers and eluate chambers;
wherein each of the anion exchange membranes and cation exchange membranes are in electrochemical and liquid communication with a neighboring pair of sorbent chambers and eluate chambers;
wherein each of the sorbent chambers further contains a lithium-selective sorbent;
a pair of terminal electrodes; and
a power source;
wherein the pair of terminal electrodes and the power source are configured to apply an electrical field across the alternating sorbent chambers and eluate chambers when a closed circuit is formed between the pair of terminal electrodes and power source;
wherein, during operation, the system is configured to sequentially operate an adsorption stage and a desorption stage;
wherein, during the adsorption stage:
the pair of terminal electrodes are not connected to the power source, such that no electrical field is applied across the alternating sorbent chambers and eluate chambers,
each sorbent chamber is configured to receive a feed solution comprising lithium, thereby contacting the lithium-selective sorbent with the feed solution, such that the lithium-selective sorbent selectively adsorbs lithium from the feed solution;
subsequently, during the desorption stage:
each sorbent chamber is configured to receive a diluate solution;
each eluate chamber is configured to receive a receiving solution;
wherein the diluate solution and receiving solution each have an initially low concentration of lithium;
a closed circuit is formed between the pair of terminal electrodes and the power source, such that the pair of terminal electrodes and the power source are configured to apply an electrical field across the alternating sorbent chambers and eluate chambers;
such that the lithium adsorbed by the lithium-selective sorbent elutes from the lithium-selective sorbent to the receiving solution, thereby forming a lithium recovery solution.

19. A method of use of the system of claim 1, wherein the method comprises electrochemical extraction of the target ion from the feed solution.

20. The method of claim 19, wherein the method comprises:
performing adsorption stage by:
contacting the feed solution with each of the sorbent chambers (e.g., flowing the feed solution through each of the sorbent chambers) in the absence of an applied electric field (e.g., wherein the circuit is open),
thereby contacting the target ion-selective sorbent with the feed solution, such that the target ion-selective sorbent selectively adsorbs the target ion from the feed solution;
subsequently stopping the contact with the feed solution; and
subsequently performing the desorption stage by:
contacting each sorbent chamber with the diluate solution (e.g., flowing the diluate solution through each sorbent chamber),
contacting each eluate chamber with the receiving solution (e.g., flowing the receiving solution through each eluate chamber), and
forming the closed circuit between the pair of terminal electrodes and the power source, such that the pair of terminal electrodes and the power source apply the electrical field across the alternating sorbent chambers and eluate chambers;
such that the target ions adsorbed by the target ion-selective sorbent elute from the target ion-selective sorbent to the receiving solution, thereby forming the target ion recovery solution.
